(19) United States
(12) Patent Application Publication
(10) Pub. No.: US 2021/0123273 A1
(43) Pub. Date: Apr. 29, 2021

(54) DOOR LOCK FOR PUBLIC RESTROOM

(71) Applicants: STEPHEN FLEMING, BRENHAM, TX (US); REBECCA COLE, BRENHAM, TX (US)

(72) Inventors: STEPHEN FLEMING, BRENHAM, TX (US); REBECCA COLE, BRENHAM, TX (US)

(21) Appl. No.: 16/667,214

(22) Filed: Oct. 29, 2019

(51) Int. Cl. E05C 19/18; E05B 65/00

(52) U.S. Cl. CPC E05C 19/182; E05B 65/0035

(57) ABSTRACT

Embodiments of the present invention disclose a portable door lock assembly that prevents rotation of a hinged stall door away from a stall wall. The assembly includes an elongated track member and a foundation member. The elongated track member having a recess and an end stop. The foundation member having a body permitted to translate along the elongated track member and includes an arm member extending outward from the body and a latch configured to selectively engage the recess of the elongated track member to selectively secure the foundation member to a position along the elongated track member.

### BACKGROUND

### 1. Field of the Invention

The present application relates to the field of door locks, and more particularly to portable door locks.

### 2. Description of Related Art

For typical public restrooms where a plurality of toilets are separated into stalls, each stall is enclosed by a hinged stall door that is locked typically using a latch that serves as a locking mechanism for securing the stall door to a stall wall. However, there are a variety of instances where the lock fails to secure the stall door to the stall wall, thereby creating an anxiety filled and potentially embarrassing restroom experience for a user. For instance, the latch may be missing entirely, the latch cannot reach a mating aperture that receives the latch, or the latch is able to reach the mating aperture, but the latch is permitted to slide out of the mating aperture. In these instances, the user must resolve to placing a hand against the stall door or otherwise vocalize the presence of the user to prevent another person from accidentally opening the stall door while the user is occupying the stall; however, this can put the user in an uncomfortable position and/or unnecessary stress on the user.

Therefore, a portable door lock is desired that can secure a public restroom stall door to a stall wall when the locking mechanism for securing the stall door to the stall wall is either missing or malfunctioned. Furthermore, it is desired that the portable door lock be in a form that is compact in order to reduce the inconvenience of carrying the portable door lock.

### SUMMARY OF THE INVENTION

Embodiments of the present invention disclose a portable door lock assembly that prevents rotation of a hinged stall door away form a stall wall. In one embodiment of the present invention, an assembly is provided comprising: an elongated track member having a recess along a first face, the elongated track member including a stop at a first end, the stop having a width larger than a width of the elongated track member; and a foundation member having a body permitted to translate along the elongated track member, the foundation member including: an arm member extending outward from the body at an angle relative to an axis of the elongated track member; and a latch coupled to the foundation member and configured to selectively engage the recess of the elongated track member, the latch configured to selectively secure the foundation member to a position along the elongated track member.

Ultimately the invention may take many embodiments. In these ways, the present invention overcomes the disadvantages inherent in the prior art.

The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions in so far as they do not depart from the spirit and scope of the present application.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a perspective view of a portable door lock assembly, in accordance with an embodiment of the present invention;

FIG. 2 is a top view of the assembly of FIG. 1;

FIG. 3 is a second top view of the assembly of FIG. 1 further illustrating components capable of translation and rotation;

FIG. 4 is a side view of the assembly of FIG. 1 having latches in an engaged position;

FIG. 5 is a second side view of the assembly of FIG. 1 having latches in a disengaged position; and

FIG. 6 is a perspective view of the door lock assembly positioned between a stall door and a stall wall as to prevent the stall door from rotating relative to the stall wall.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The assembly and method in accordance with the present invention overcomes one or more of the above-discussed problems commonly associated with public bathroom door stall locks. In particular, the system of the present invention is a portable door lock assembly having an elongated track member, one or more foundation members, the one or more foundation members having a corresponding one or more arm members, and one or more latches in communication with a foundation member, the foundation member permitted to translate along the elongated track member wherein the one or more latches selectively engages the elongated track member. The portable door lock prevents rotation of a hinged stall door away from a stall wall by positioning planar faces of the stall door and the stall wall between one or more arm members of the foundation member and one or more arm members located proximate to a first end of the elongated track member. Furthermore, the one or more latch members corresponding to the one or more foundation members are configured to pivot relative to the corresponding one or more foundation members, thereby permitting compact storage and transportation of the portable lock assembly. These and other unique features of the system are discussed below and illustrated in the accompanying drawings.

The system will be understood from the accompanying drawings, taken in conjunction with the accompanying description. Several embodiments of the system may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The system of the present application is illustrated in the associated drawings. As used herein, “system” and “assembly” are used interchangeably. As used herein, a “fastener” is a rod-like hardware device that mechanically joins or affixes two or more members together through a respective concentric set of apertures. For example, a fastener can be a screw, bolt, nail, stud, dowel, rivet, staple, etc. in conjunction with any applicable nuts and washers generally known in the art of fastening. It should be noted that the articles “a”, “an”, and “the”, as used in this specification, include plural referents unless the content clearly dictates otherwise. Additional features and functions are illustrated and discussed below.

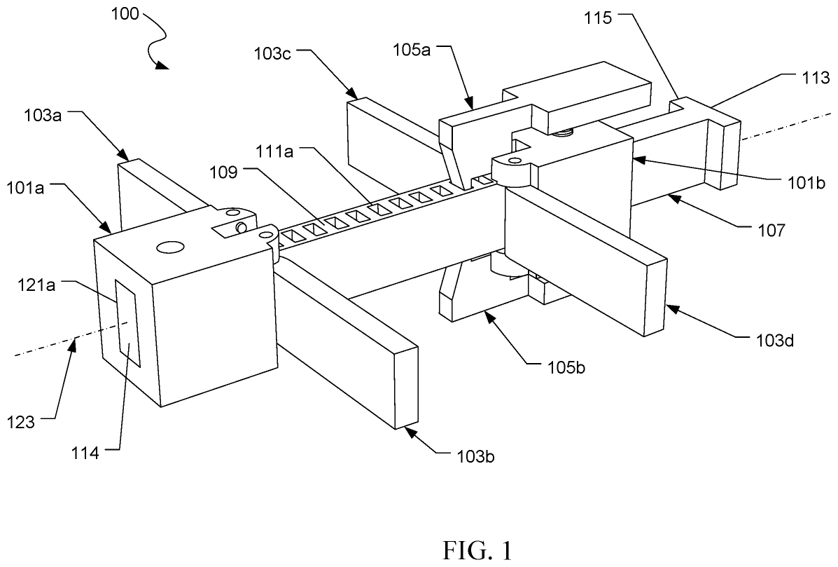

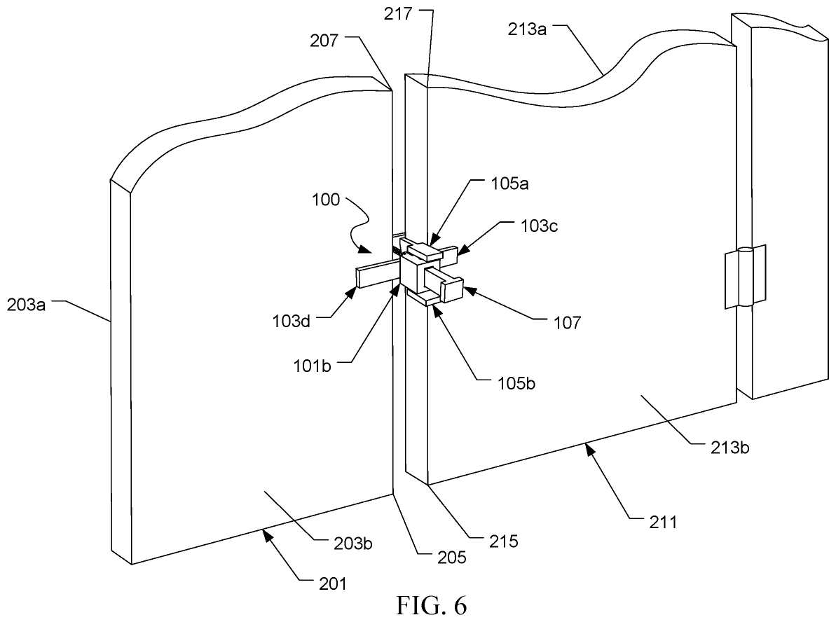

Referring now to the drawings wherein like reference characters identify corresponding or similar elements in form and function throughout the several views. FIGS. 1-5 illustrate various views of a portable lock assembly as well as illustrating motion of components of the assembly. FIG. 6 illustrates the use of the portable lock assembly in securing a stall door relative to a stall wall.

Referring now to FIG. 1, a perspective view of portable door lock assembly 100 is illustrated in accordance with an embodiment of the present invention.

In FIG. 1, portable door lock assembly 100 (herein further referred to as assembly 100) is a portable door lock that prevents rotation of a hinged stall door respective to a stall wall. Assembly 100 comprises elongated track member 107, first foundation member 101b, second foundation member 101a, arm members 101c and 101d in communication with first foundation member 101b, arm members 101a and 101b in communication with second foundation member 101a, and latches 105a and 105b in communication with first foundation member 101b.

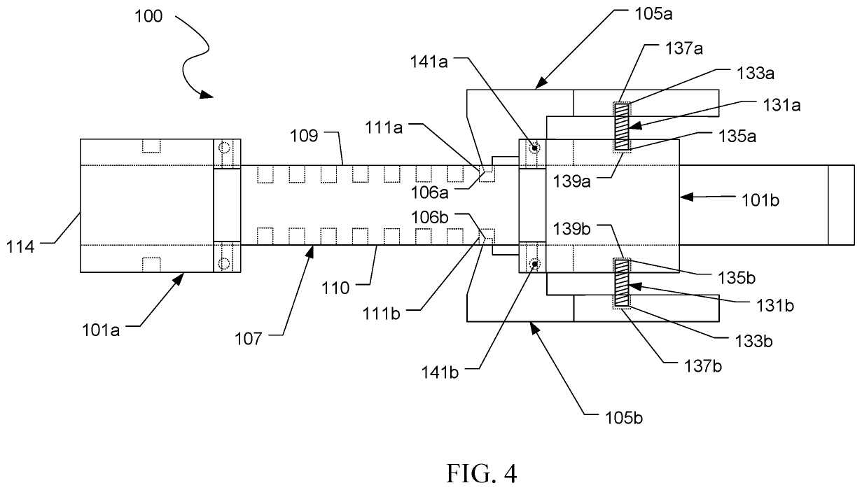

Track member 107 has a first face (i.e. face 109), a second face (i.e., face 110) further depicted in FIG. 4, a first end (i.e., end 113), and a second end (i.e., end 114). Track member 107 has an axis (i.e., axis 123) that runs between end 113 and end 114, axis 123 being a locational reference for relative components of assembly 100. Track member 107 also includes an optional stop 115 located proximate to end 113.

Furthermore, track member 107 has a first recess (i.e., recess 111a) located on face 109 with an optional further second recess (i.e., recess 111b) located on face 110, as seen in FIG. 4.

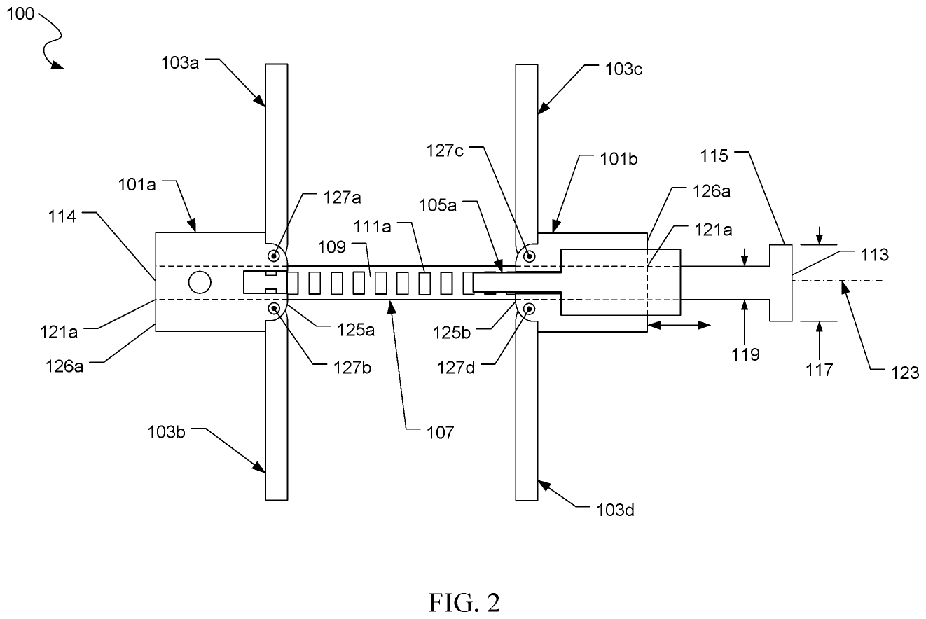

Foundation member 101a and foundation member 101b have the same form and physical features unless explicitly stated herein. Foundation member 101a is coupled to end 114 of track member 107. Foundation member 101b has a body that is permitted to translate along track member 107. Latches 105a and 105b that are in communication with foundation member 101b are configured to selectively engage a corresponding recess of track member 107, wherein the latches are configured to selectively secure foundation member 101b to a position along track member 107. Additional features of foundation members 101a-b and associated components are further described and illustrated with respect to FIGS. 2-5.

Referring now to FIG. 2, a top view of portable door lock assembly 100 is illustrated in accordance with the embodiment of the present invention.

Both foundation members 101a and 101b have a first face (i.e., face 125a and face 125b, respectively) and a second face (i.e., face 126a and face 126b, respectively). Furthermore, both foundation members 101a and 101b have an aperture (i.e., aperture 121a and 121b, respectively) that passes from the first face and the second face of each foundation member, wherein the aperture is configured to receive track member 107. Foundation member 101b is permitted to translate along track member 107 according to track member 107 passing through aperture 121a. Foundation member 101a is coupled to end 114 of track member 107. For example, foundation member 101a is coupled to end 114 by an adhesive material (e.g., glue or bonding agent) applied between aperture 121a and a portion of track member 107 that is located proximate to end 114, wherein the adhesive material permanently couples foundation member 101a to track member 107. In another example, foundation member 101a is coupled to end 114 via an interference fit between aperture 121a and a portion of track member 107 that is located proximate to end 114. In this example, aperture 121a of foundation member 101a is smaller than aperture 121b of foundation member 101b such that aperture 121a permits an interference fit between foundation member 101a and track member 107, while aperture 121b permits foundation member 101b to translate along track member 107.

Stop 115 of track member 107 is an end stop that prevents foundation member 101b from decoupling from track member 107. Stop 115 has a width (i.e., stop width 117) larger than a width of track member 107 (i.e., track width 119). Subsequently, the width of stop width 117 is larger than aperture 121a of foundation member 101b thereby preventing foundation member 101b from decoupling from track member 107 from end 113.

Foundation members 101a and 101b are oriented such that face 125a of foundation member 101a and face 125b of foundation member 101b are oppositely facing each other. Arm members 103a and 103b are coupled to foundation member 101a located proximate to face 125a, and arm members 103c and 103d are coupled to foundation member 101b located proximate to face 125b. Arm members 103a and/or 103b extend outward from foundation member 101a at an angle relative to axis 123. Arm members 103c and/or 103d extend outward from foundation member 101a at an angle relative to axis 123.

Each arm member is configured to pivot relative to each foundation member about an arm axis for compact storage and transportation. For example, as illustrated in FIG. 2, arm member 103a is coupled to foundation member 101a such that arm member 103a is permitted to pivot according to axis 127a. In this example, arm member 103a is connected to foundation member 103a using a hinge to permit arm member 103a to pivot according to the hinge. In similar form and function, arm member 103b is permitted to pivot according to axis 127b. For foundation member 101b, arm member 103c is permitted to pivot according to axis 127c, and arm member 103d is permitted to pivot according to axis 127d.

Optionally, in its most distilled form without sacrificing functionality, portable door lock assembly 100 may have one arm member in communication with each foundation member, wherein respective arm members are opposite across track member 107. For example, foundation member 101a has arm member 103b while foundation member 101b has arm member 103c, or foundation member 101a has arm 103a while foundation member 101b has arm member 103d.

Optionally, portable door lock assembly 100 may not have foundation member 101a, but instead have foundation member 101b oriented such that arm members 103c and 103d are located on a face of foundation member 101b closest to stop 115 (i.e., face 125b is oriented to face towards stop 115). In this orientation, portable door lock assembly 110 holds a hinged public restroom stall door in a closed position with respect to a restroom stall wall by positioning the stall door and the stall wall between arm members 103c-d and stop 115.

Optionally, portable door lock assembly 100 does not include an end stop.

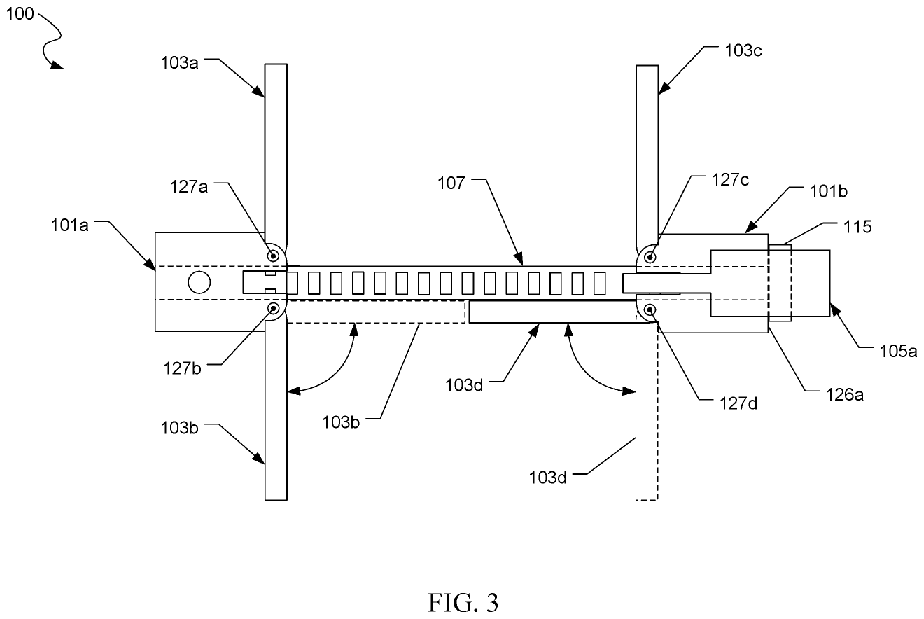

Referring now to FIG. 3, a second top view of portable door lock assembly 100 is illustrated in accordance with the embodiment of the present invention.

In this figure, foundation member 101b is translated away from foundation member 101a until face 126a of foundation member 101b is in contact with stop 115. In this position, one or more arm members corresponding to each foundation member may pivot with respect to corresponding axes to permit compact storage and transportation. For example, arm member 103b and arm member 103d are permitted to pivot with respect to axis 127b and axis 127d such that arm member 103b and 103d are permitted to be planarly flush against track member 107.

Referring now to FIG. 4, a side view of portable door lock assembly 100 having latches in an engaged position is illustrated in accordance with the embodiment of the present invention.

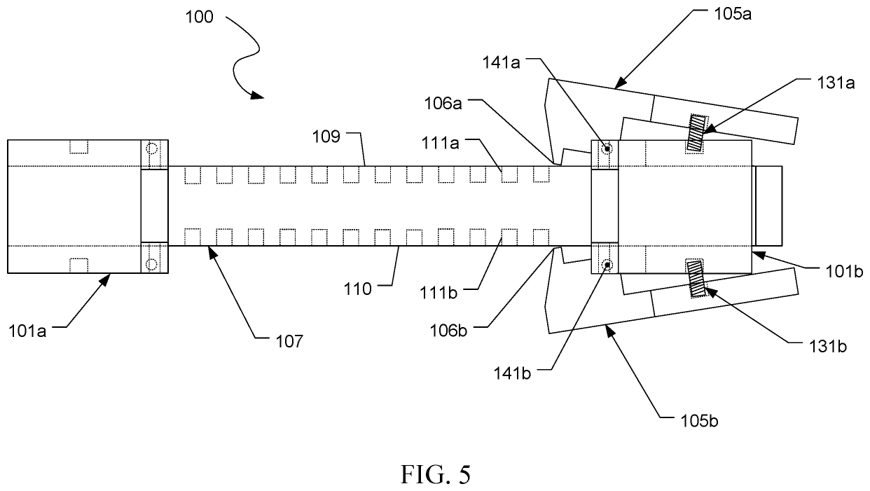

One or more latches in communication with foundation member 101b are configured to pivot so as to selectively engage a corresponding one or more recesses located along track member 107, the one or more latches permitting selective translation of foundation member 101b along track member 107. For example, in FIG. 5, latches 105a and 105b are oppositely facing latches in communication with foundation member 101b having a corresponding latch tooth 106a and 106b. Latch 105a is coupled to foundation member 101a such that latch 105a is permitted to pivot according to axis 141a. In this example, latch 105a is connected to foundation member 103a using a hinge to permit latch 105a to pivot according to the hinge. In similar form and function, Latch 105b is coupled to foundation member 101a such that latch 105b is permitted to pivot according to axis 141b. In FIG. 4, latch tooth 106a of latch 105a corresponds to recess 111a located on face 109 of track member 107, and latch tooth 106b of latch 105b corresponds to recess 111b located on face 110, wherein face 109 and face 110 are on opposing faces of track member 107.

The one or more latches are spring biased to maintain contact with track member 107 when at rest. For example, in FIG. 4, latch 105a and foundation member 101b have apertures 137a and 139a respectively, wherein spring 131a has a first end (i.e., spring end 133a) in communication with aperture 137a of latch 105a and a second end (i.e., spring end 135a) in communication with aperture 139a of foundation member 101b. In this example, spring 131a applies a spring force between latch 105a and foundation member 101b, subsequently engaging latch 105a with track member 107. In similar form and function as latch 105a, latch 105b and foundation member 101b have apertures 137b and 139b respectively, wherein spring 131b has a first end (i.e., spring end 133b) in communication with aperture 137b of latch 105b and a second end (i.e., spring end 135b) in communication with aperture 139b of foundation member 101b. The one or more latches passes into the corresponding one more recesses at rest and are pivoted out of the one or more recesses when the spring is compressed so as to permit translation of foundation member 107.

While the one or more latches are engaged with one or more recesses of track member 107, the engagement between the one or more latches with the corresponding one or more recesses prevents foundation member 101b from translating a direction along track member 107, wherein the direction is away from end 114 of track member 107.

Referring now to FIG. 5, a second view of portable door lock assembly 100 having latches in a disengaged position is illustrated in accordance with the embodiment of the present invention.

In this figure, latch 105a and 105b are disengaged from track member 107 such that latch 105a and 105b are compressed against the spring of each latch that maintains contact with track member 107, thereby disengaging latch tooth 106a and latch tooth 106b from corresponding recesses 111a and 111b, subsequently permitting foundation member 101b to translate along track member 107.

Referring now to FIG. 6, a perspective view of portable door lock assembly 100 positioned between stall door 211 and stall wall 201 is illustrated in accordance with the embodiment of the present invention.

In this figure, stall door 211 is a hinged door that is in a closed position relative to stall wall 201. In this figure, a user has positioned portable door lock assembly 100 between stall door 211 and stall wall 201 to lock stall door 211 in the close position.

In this figure, stall wall 201 has a front side (i.e., side 203a), a back side (i.e., side 203b), a first end (i.e., end 205), and a second end (i.e., end 207). Furthermore, stall door 211 has a front side (i.e., side 213a), a back side (i.e., side 213b), a first end (i.e., end 215), and a second end (i.e., end 217). Portable door lock assembly 100 is positioned between stall door 211 and stall wall 201 such that track member 107 is in between planar surfaces of stall door 211 and stall wall 201, and foundation member 101b is translated into a position where one or more arm members of foundation member 101b are planarly flush with side 203b of stall wall 201 and side 213b of stall door 211, and one or more arm members of foundation member 101a are planarly flush with side 203a of stall wall 201 and side 213a of stall door 211. For example, in this figure, arm member 103d is against side 203b, arm member 103c is against side 213b, arm member 103a is against side 213a (obscured from view), and arm member 103b is against side 203a (obscured from view).

To use portable door lock assembly 100, a user performs the following method:

The user rotates one or more arm members of foundation member 101b (e.g., arm members 103c and 103d) such that the one or more arm members are at an angle relative to axis of 213 of track member 107. Optionally, the user rotates one or more arm members associated with track member 107 such that the one or more arm members are at a second angle relative to axis 213 of track member 107.

The user then positions portable lock assembly 100 between stall door 211 and stall wall 201, wherein stall door 211 and stall wall 201 are located between the one or more arm members of foundation member 101b and the one or more arm members associated with track member 107 (e.g., arm members 103a and 103b, or stop 115). The user either positions portable lock assembly 100 by translating portable door lock assembly 100 between stall wall 201 and stall door 211 from end 205 and end 215 of stall wall 201 and stall door 211 respectively, or from end 207 and 217 of stall wall 201 and stall door 211. The user then translates foundation member 101b along track member 107 towards the one or more arms associated with track member 107. For example, the user translates foundation member 101b towards foundation member 101a. In another example, the user translates foundation member 101b towards stop 115. Lastly, the user locks foundation member 101b with respect to track member 107. The user locks foundation member 101b with respect to track member 107 by engaging one or more latches (e.g., latches 105a and 105b) with a corresponding one or more recesses of track member 107 (e.g., recess 111a and 111b), wherein the one or more latches are spring biased to engage with the one or more recesses. In this position, portable door lock assembly 100 restricts stall door 211 from pivoting away from stall wall 201.

To remove portable lock assembly 100 from stall wall 201 and stall door 211, the user unlocks foundation member 101b with respect to track member 107. The user unlocks foundation member 101b with respect to track member 107 by disengaging one or more latch members from the corresponding one or more recesses of track member 107. For example, the user compresses the one or more latches against the spring of the one or more latches to disengage the one or more latches from the corresponding one or more recesses. The user then translates foundation member 101b along track member 107 away from the one or more arm members associated with track member 107. The user then removes portable lock assembly 100 from stall wall 201 and stall door 211. For example, the user removes portable lock assembly 100 by translating portable lock assembly 100 off either ends 205 and 215 or off ends 207 and 217. Lastly, the user rotates the one or more arm members of foundation member 101b such that the one or more arm members are parallel to track member 107. Optionally, the user rotates the one or more arm members associated with track member 107 such that the one or more arm member associated with track member 107 are parallel to track member 107.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A portable door lock assembly, comprising:
an elongated track member having a recess along a first face, the elongated track member including a stop at a first end, the stop having a width larger than a width of the elongated track member; and
a foundation member having a body permitted to translate along the elongated track member, the foundation member including:
an arm member extending outward from the body at an angle relative to an axis of the elongated track member; and
a latch coupled to the foundation member and configured to selectively engage the recess of the elongated track member, the latch configured to selectively secure the foundation member to a position along the elongated track member.

2. The assembly of claim 1, wherein the arm member is located on a face of the foundation member closest to the stop.

3. The assembly of claim 1, wherein the arm member is configured to pivot relative to the body about an arm axis for compact storage and transportation.

4. The assembly of claim 1, wherein the latch is configured to pivot so as to selectively engage the recess, the latch permitting selective translation of the foundation member along the track.

5. The assembly of claim 4, wherein the latch is spring biased to maintain contact with the elongated track member when at rest.

6. The assembly of claim 5, wherein the latch passes into the recess at rest and is pivoted out of the recess when the spring is compressed so as to permit translation of the foundation member.

7. The assembly of claim 1, further comprising:
a second foundation coupled to a second end of the elongated track member, the second foundation member having a second arm member.

8. The assembly of claim 7, wherein the arm member and the second arm member are located on opposing faces of the foundation member and the second foundation member, the foundation member being able to translate relative to the second foundation member.

9. The assembly of claim 7, wherein the second arm member is configured to pivot relative to a body of the second foundation member.

10. The assembly of claim 7, wherein both the arm member and the second arm member are configured to pivot relative to the elongated track member about a corresponding set of arm axis.

11. The assembly of claim 1, further comprising:
the elongated track member having a second recess along a second face, the second face opposing the first face; and
the foundation member having a second latch coupled to the foundation member and configured to selectively engage the second recess of the elongated track member, the second latch configured to selectively secure the position of the foundation member along the track.

12. The assembly of claim 11, wherein the latch and the second latch are each configured to pivot so as to selectively engage the recess, the latch and the second latch permitting selective translation of the foundation member along the track.

13. A method for using a portable door lock assembly for holding a hinged stall door in a closed position with respect to a restroom stall wall, the method comprising:
rotating one or more arm members of a foundation member such that the one or more arm members are at an angle relative to an axis of an elongated track member;
positioning the portable door lock assembly between the stall door and the stall wall, wherein the stall door and the stall wall are located between the one or more arm members of the foundation member and one or more arm members of the elongated track member, the one or more arm members of the track member being located proximate to a first end of the track member;
translating the foundation member along the track member towards the first end of the track member; and
locking the foundation member with respect to the elongated track member.

14. The method of claim 13, further comprising:
rotating the one or more arm members of the elongated track member such that the one or more arm members are at a second angle relative to the axis of the elongated track member.

15. The method of claim 13, wherein locking the foundation member with respect to the track member includes one or more latch arms in communication with the foundation member, the one or more latch arms configured to selectively engage with a corresponding one or more recesses of the elongated track member, wherein the engagement between the one or more latches with the corresponding one or more recesses prevents the foundation member from translating a direction along the track member.

16. The method of claim 15, wherein the direction along the track member is away from the first end of the track member.

17. The method of claim 15, wherein positioning the portable door lock assembly between the stall door and the stall wall further comprises translating the portable door lock assembly between the stall door and the stall wall from a first end of the stall door and the stall wall.

18. The method of claim 15, wherein positioning the portable door lock assembly between the stall door and the stall wall further comprises translating the portable door lock assembly between the stall door and the stall wall from a second end of the stall door and the stall wall.

19. The method of claim 13, further comprising:
unlocking the foundation member with respect to the track member;
translating the foundation member along the track member away from the first end of the track member;
removing the portable door lock assembly from the stall door and the stall wall; and
rotating the one or more arm members of the foundation member such that the one or more arm members of the foundation member are parallel to the track member.

20. The method of claim 19, wherein unlocking the foundation member with respect to the track member further comprises disengaging one or more latch members from a corresponding one or more recesses of the track member.
